(19) United States
(12) Patent Application Publication
(10) Pub. No.: US 2026/0119187 A1
(43) Pub. Date: Apr. 30, 2026

(54) AUTOMATED CONFIGURATION OF CLOUD-BASED ARTIFICIAL-INTELLIGENCE AGENT THAT UTILIZES ON-PREMISE TOOL

(71) Applicant: BOOMI, LP, Conshohocken, PA (US)

(72) Inventors: Michael J. Hudson, Delray Beach, FL (US); Lomesh AGRAWAL, Toronto (CA); Christopher PEDROTTI, San Jose, CA (US)

(73) Assignee: BOOMI, LP, Conshohocken, PA (US)

(21) Appl. No.: 19/044,302

(22) Filed: Feb. 3, 2025

(30) Foreign Application Priority Data
Oct. 25, 2024 (IN) 202411081538

(51) Int. Cl. G06F 9/4401

(52) U.S. Cl. CPC G06F 9/4401

(57) ABSTRACT

Artificial intelligence (AI) agents are increasingly being used to automate tasks within integration environments. However, a problem occurs in hybrid environments in which the AI agent is hosted in a cloud-computing environment, whereas the tools, required by the AI agent, are hosted on an on-premise system of an organization. In this case, the AI agent may not know the organization-specific operations available through the on-premise tool—let alone, the requirements of those operations. Accordingly, embodiments enable an AI agent to automatically learn the specific operations, including the requirements (e.g., inputs and outputs) of those operations, during installation and/or execution, via a predefined discovery operation that is implemented by the application programming interface of every on-premise tool. This enables the addition of AI agents to the cloud-computing environment in a scalable manner, by allowing the AI agents to automatically and dynamically adapt to the capabilities of each on-premise tool.

### CROSS-REFERENCE TO RELATED APPLICATIONS

The present application claims priority to Indian Patent Application No. 202411081538, filed on Oct. 25, 2024, which is hereby incorporated herein by reference as if set forth in full.

### BACKGROUND

### Field of the Invention

The embodiments described herein are generally directed to artificial intelligence (AI) systems, and, more particularly, to cloud-based AI agents that interact with on-premises tools, for example, during real-time chat sessions.

### Description of the Related Art

Integration Platform as a Service (iPaaS) enables the integration of applications and data on demand. The iPaaS platform provided by Boomi® of Conshohocken, Pennsylvania, enables users to construct, deploy, and otherwise manage integration processes on an integration platform. To aid users in the management of their integration platforms, the operator of the iPaaS platform, the user of the iPaaS platform, and/or one or more third parties may deploy artificial-intelligence (AI) agents within a cloud-computing environment.

An AI agent is a software entity that utilizes artificial intelligence (e.g., machine learning, natural-language processing, data analytics, etc.) to autonomously perform a task, in order to achieve an objective set by a human, other AI agent, or other system. An AI agent may collect data, analyze data, learn and improve, communicate with human users and/or other software entities, collaborate with other AI agents to complete a complex task, execute actions, and/or the like. Advantages of AI agents include, without limitation, enhanced efficiency, improved customer satisfaction, perpetual availability, scalability, data-driven insight, consistency, accuracy, and the like.

AI agents may be utilized within an iPaaS platform to autonomously perform integration-related tasks, such as customer support, software design, code generation, conversational assistance, and the like. For example, an AI agent could be used to automatically map and/or transform data, orchestrate and/or optimize workflows, identify patterns and predict potential issues with integration processes, detect and/or resolve errors in integration processes, design steps in an integration process and/or entire integration processes based on a natural-language input from a user, otherwise interact with users through natural language, dynamically scale and adjust integration processes and/or the runtimes in which they execute, detect and/or mitigate security threats or compliance risks, identify and protect personally identifiable information, discover application programming interfaces (APIs), optimize API calls, monitor parameters of integration processes and/or integration platforms in real time for real-time alerts, provide next-step best practices, document integration processes (e.g., for improved version control), provide technical support, streamline data synchronization, enhance data quality, and/or the like.

Increasingly, AI agents, designed for real-time chat, are being utilized to automate various tasks. These AI agents often need to access data and/or perform actions using tools that are hosted on an organization's on-premise system. This presents a challenge when the AI agent is hosted in a cloud-computing environment. Currently, most AI agents lack direct integration with the on-premise system, which results in inefficiencies, reliance on middleware, and/or the need for manual intervention.

### SUMMARY

Accordingly, systems, methods, and non-transitory computer-readable media are disclosed for seamless, secure integration between cloud-based AI agents and on-premise systems, for example, during real-time chat sessions between the AI agents and their users. Embodiments may reduce or eliminate the need for manual system access, while maintaining secure and structured communications between the cloud and on-premise environments.

In an embodiment, a method comprises using at least one hardware processor to, for each of one or more artificial-intelligence (AI) agents: receive a request to configure the AI agent within a cloud-computing environment, wherein the AI agent utilizes at least one on-premise tool to perform a task, and wherein the at least one on-premise tool is hosted on an on-premise system that is remote from the cloud-computing environment; receive application programming interface (API) information for the at least one on-premise tool; query a predefined discovery operation, within an application programming interface of the at least one on-premise tool, based on the API information; receive capabilities of the at least one on-premise tool from the predefined discovery operation, wherein the capabilities comprise one or more operations available within the application programming interface of the at least one on-premise tool; and register at least a subset of the one or more operations, as available to the AI agent during subsequent execution of the AI agent. The one or more AI agents may be a plurality of AI agents, wherein all of the application programming interfaces of all of the on-premise tools include the predefined discovery operation.

The capabilities may further comprise a list of fields for each of the one or more operations. The list of fields may comprise one or both of one or more input fields or one or more output fields. The capabilities may further comprise a data schema of each of the one or more operations.

The request to configure the AI agent may be received during installation of the AI agent. The request to configure the AI agent may be received at a time of or during execution of the AI agent.

The one or more operations may be a plurality of operations, wherein registering at least a subset of the one or more operations as available to the AI agent during execution of the AI agent comprises: prompting a user to select one or more of the plurality of operations; receiving a selection of at least one of the plurality of operations from the user; and registering the selected at least one operation, without registering any unselected ones of the plurality of operations, as the at least a subset of the one or more operations that are available to the AI agent during execution of the AI agent.

The method may further comprise, for each of the one or more AI agents, during execution of the AI agent: receive an input from a user; determine at least one of the at least a subset of the one or more operations, available within the application programming interface of the at least one on-premise tool and available to the AI agent, to be used in response to the input; and call the at least one operation. The method may further comprise, for each of the one or more AI agents, during execution of the AI agent: generate a response to the input using an AI model and a result of the call to the at least one operation; and output the response to the user. The AI model may be a generative language model, wherein the response comprises a natural-language expression. Generating the response to the input may comprise: generating a prompt based on the result of the call to the at least one operation; and inputting the prompt to the generative language model to produce the response. The AI agent may implement a real-time chat session with the user, wherein the input comprises a natural-language expression. The at least one operation may retrieve and return, as a result, data from the on-premise system on which the at least one on-premise tool is hosted. The at least one operation may perform an action through the on-premise system on which the at least one on-premise tool is hosted. The action may comprise completing a transaction between the on-premise system, on which the at least one on-premise tool is hosted, and a third-party system.

The cloud-computing environment may be hosted on an integration platform as a service (iPaaS) platform.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates a process for configuring an artificial intelligence (AI) agent that may utilize on-premise tools, according to an embodiment; and

FIG. 4 illustrates a process for executing an artificial intelligence (AI) agent that may utilize on-premise tools, according to an embodiment.

### DETAILED DESCRIPTION

In an embodiment, systems, methods, and non-transitory computer-readable media are disclosed for cloud-based AI agents that interact with on-premises tools, for example, during real-time chat sessions. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Infrastructure

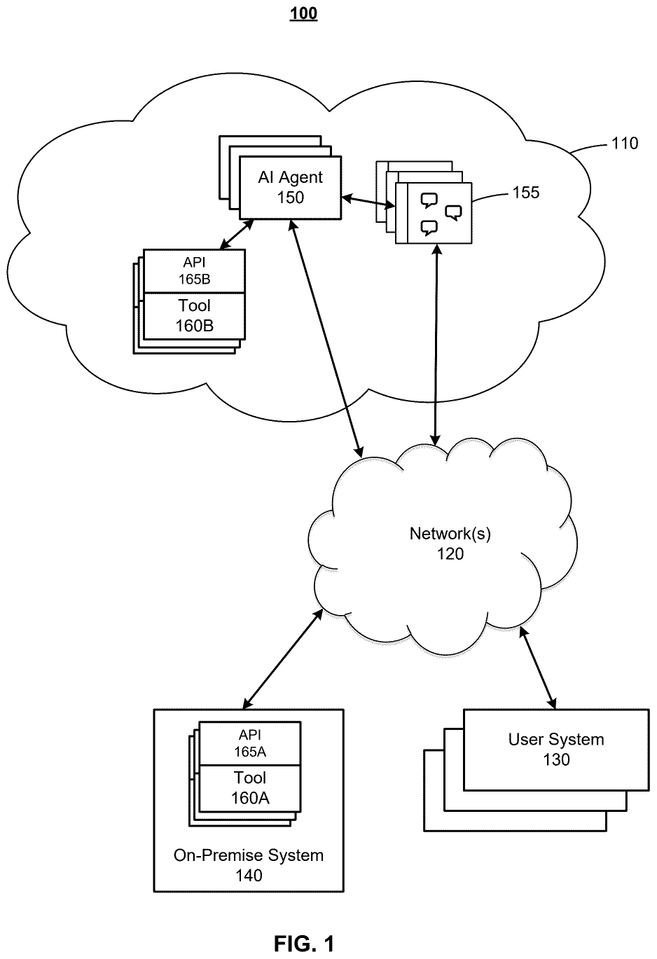

FIG. 1 illustrates an example infrastructure 100, in which one or more of the processes described herein may be implemented, according to an embodiment. Infrastructure 100 may comprise a cloud-computing environment 110 which hosts and/or executes one or more of the disclosed processes, which may be implemented in software and/or hardware. Cloud-computing environment 110 is a server environment in which computing services are dynamically and elastically allocated to one or more tenants based on demand. The servers may be collocated and/or geographically distributed within one or more data centers. Cloud-computing environment 110 may be a public cloud (e.g., owned and operated by a different party than the tenant(s)), a private cloud (e.g., dedicated to a single tenant), or a hybrid cloud (e.g., comprising a combination of public and private cloud elements).

Cloud-computing environment 110 may be communicatively connected to one or more networks 120. Network(s) 120 enable communication between cloud-computing environment 110, user system(s) 130, and on-premise system(s) 140. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While cloud-computing environment 110 is illustrated as being connected to a plurality of user systems 130 and/or on-premise systems 140 through a single set of network(s) 120, it should be understood that platform 110 may be connected to different user systems 130 and/or on-premise systems 140 via different sets of one or more networks. For example, platform 110 may be connected to a subset of user systems 130 and/or on-premise systems 140 via the Internet, but may be connected to another subset of user systems 130 and/or on-premise systems 140 via an intranet.

While only a few user systems 130 are illustrated, it should be understood that cloud-computing environment 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of a user (e.g., an integration developer) that has a user account for accessing an AI agent 150 in cloud-computing environment 110. In an embodiment in which cloud-computing environment 110 supports an iPaaS platform, each user account may be associated with an overarching organizational account for managing an integration platform on the iPaaS platform.

The user of a user system 130 may interact with AI agent(s) 150, via user interface 155, to, for example, perform a task. It should be understood that multiple users, on multiple user systems 130, may interact with the same AI agent(s) 150 and/or different AI agent(s) 150 in this manner, according to the permissions or roles of their associated user accounts. Although only a few AI agents 150 are illustrated, it should be understood that, in reality, cloud-computing environment 110 may comprise any number of AI agents 150.

In an embodiment, cloud-computing environment 110 supports integration platform as a service (iPaaS). In this case, cloud-computing environment 110 may comprise one or a plurality of integration platforms that each comprises one or a plurality of integration processes. Each integration platform may be associated with an organization, which may be associated with one or more user accounts by which respective user(s) manage the organization's integration platform, including the various integration process(es).

An integration process may represent a transaction involving the integration of data between two or more systems, and may comprise a series of elements that specify logic and transformation requirements for the data to be integrated. Each element, which may also be referred to herein as a “step,” may transform, route, and/or otherwise manipulate data to attain an end result from input data. For example, a basic integration process may receive data from one or more data sources, manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

In an embodiment, each AI agent 150 comprises or is communicatively coupled to at least one AI model (not shown). The AI model may be a generative AI model, such as a generative language model, such as a large language model. One well-known example of a large language model is the Generative Pre-trained Transformer (GPT). GPT-4 is the fourth-generation language prediction model in the GPT-n series, created by OpenAI™ of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the Claude family of large language models (e.g., Claude 3 Opus) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLAMA 2) released by Meta AI of New York, New York, the Gemini model, the Mistral family of models released by Mistral AI of Paris, France, and the like. Alternatively or additionally, the generative language model may comprise or consist of a code-completion model that is trained to produce source code, data structures represented in a markup language (e.g., XML, HTML, etc.) or other format, and/or the like. A pre-trained generative language model may used as a base model that is fine-tuned for the specific task of the respective AI agent 150.

In an embodiment, each AI agent 150 may be communicatively coupled to zero, one, or a plurality of tools 160. Each tool 160 may be perform a sub-task for the specific task of the respective AI agent 150. A sub-task may comprise retrieving data from a source (e.g., another AI agent 150, an on-premise system 140, a local or remote database, a third-party application or database, an integration process, etc.), transforming, formatting, mapping, cleaning, or otherwise manipulating data, analyzing data, storing data, sending data (e.g., tabular or other structured data, unstructured data, commands, requests, queries, etc.) to a destination (e.g., another AI agent 150, an on-premise system 140, a local or remote database, a third-party application or database, an integration process, etc.), initiating a transaction (e.g., purchase, sale, exchange, trade, etc.), completing a transaction, and/or the like.

An AI agent 150 may be incorporated into one or more steps of an integration process (e.g., on an integration platform, hosted on an iPaaS platform). For example, a step of an integration process may call an AI agent 150 to perform a task, such as retrieve data, perform an action, and/or the like. Alternatively or additionally, an AI agent 150 may call an integration process as a tool 160 to retrieve data, perform an action, and/or the like. However, it should be understood that an AI agent 150 does not necessarily have to interact with any integration process. For example, an AI agent 150 could provide customer support (e.g., on an iPaaS platform), identify gaps in an organization's integration platform, or perform some other function that is not directly related to an integration process.

In a contemplated embodiment, AI agent 150 implements a real-time chat session, in which a user chats or otherwise interacts with AI agent 150 in real time, via user interface 150, which may comprise or consist of a graphical user interface, audio interface, and/or the like. During this chat session, AI agent 150 may utilize one or more tools 160, potentially including an integration process, to retrieve data, perform an action, and/or the like. As one specific, non-limiting example, the user may request an AI agent 150 to procure new equipment (e.g., a computer), and AI agent 150 may utilize one or more tools 160 to initiate an integration process to order or otherwise procure the new equipment.

Tool(s) 160 may comprise on-premise tool(s) 160A and/or cloud-based tool(s) 160B. As used herein, a reference numeral with an appended letter will be used to refer to a specific component, whereas the same reference numeral without any appended letter will be used to refer collectively to a plurality of the component or to refer to a generic or arbitrary instance of the component. Thus, for example, the term “tools 160” refers collectively to on-premise tools 160A and cloud-based tools 160B, and the term “tool 160” may refer to any single one of an on-premise tool 160A or cloud-based tool 160B.

At least one of the tool(s) 160 used by an AI agent 150 may be an on-premise tool 160A that is hosted on an on-premise system 140, which is remote from cloud-computing environment 110, in which the AI agent 150 is hosted. In this case, each on-premise system 140 may be communicatively connected to network(s) 120, such that on-premise system 140 may communicate with an AI agent 150 in cloud-computing environment 110 via an application programming interface. An AI agent 150 may push data to a software application on on-premise system 140 and/or pull data from a software application on on-premise system 140, via an application programming interface of the on-premise system 140. Alternatively or additionally, a software application on on-premise system 140 may push data to an AI agent 150 and/or pull data from an AI agent 150, via an application programming interface of AI agent 150. Thus, on-premise system 140 may be a consumer or other destination of data from one or more AI agents 150, a data source for one or more AI agents 150, a control target for one or more AI agents, and/or the like. As examples, the software application on on-premise system 140 may comprise, without limitation, enterprise resource planning (ERP) software, customer relationship management (CRM) software, procurement software, accounting software, and/or the like.

In an embodiment, on-premise system 140 may comprise one or more on-premise tools 160A that are used by one or more AI agents 150 within cloud-computing environment 110. Each AI agent 150 may communicate with each of one or more on-premise tools 160A on an on-premise system 140 via an application programming interface 165A of that on-premise tool 160A. Application programming interface 165A for each on-premise tool 160A may be exposed to network(s) 120, for example, through a firewall, with specific connectivity (e.g., using a predefined port) provided to AI agent(s) 150.

Each application programming interface 165A of each on-premise tool 160A, and optionally, each application programming interface 165B of each cloud-based tool 160B, may comprise or be configured to provide a discovery operation that returns the capabilities (e.g., available operations) of the respective tool 160. The discovery operation may have a standardized definition across application programming interfaces 165A of all on-premise tools 160A, and potentially across application programming interfaces 165B of cloud-based tools 160B. In an embodiment, all of application programming interfaces 165A of all on-premise tools 160A could include the same predefined discovery operation. The capabilities, returned by each discovery operation, may comprise one or more operations available within the application programming interface 165 of the respective tool 160, a list of fields for each of the operation(s), including one or more input fields and/or one or more output fields, a data schema of each of the operation(s), including an input data schema and/or output data schema, and/or the like. For tools 160 that do not natively implement a discovery operation, the hosting system (e.g., on-premise system 140 for on-premise tool 160A, or cloud-computing environment 110 for cloud-based tool 160B) may provide mechanisms to add a discovery operation or simulate the functionality of the discovery operation. The discovery operation may be added by a developer of the tool 160 or by an operator of the system (e.g., integration platform, cloud-computing environment 110, on-premise system 140, etc.) that hosts the tool 160, or through an automated process. The hosting system may also support various industry-standard protocols that are designed to facilitate tool discovery and integration.

It should be understood that an AI agent 150 may communicate with each of one or a plurality of on-premise tools 160A on the same on-premise system 140 and/or a plurality of on-premise tools 160A across a plurality of on-premise systems 140. In addition, a first AI agent 150 may communicate with the same on-premise tool 160A on the same on-premise system 140 as a second AI agent 150, a different on-premise tool 160A on the same on-premise system 140 as a second AI agent 150, the same on-premise tool 160A on a different on-premise system 140 as a second AI agent 150, a different on-premise tool 160A on a different on-premise system 140 as a second AI agent 150, and/or the like. AI agents 150 may interact with cloud-based tools 160B in the same manner. In other words, AI agents 150 may operate, within cloud-computing environment 110, independently from each other, using an overlapping or non-overlapping set of one or more tools 160 that is relevant to the specific task of the respective AI agent 150. It should be understood that an on-premise system 140 could alternatively or additionally host on-premise AI agents, but that these are not the focus of disclosed embodiments.

### 2. Example Processing System

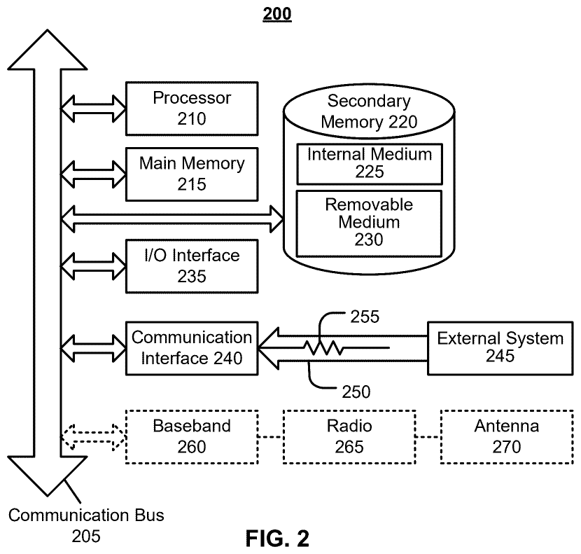

FIG. 2 illustrates an example processing system, by which one or more of the processes described herein may be executed, according to an embodiment. For example, system 200 may be used to store and/or execute server application 112, and/or may represent components of platform 110, user system(s) 130, on-premise system 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. Example Configuration of AI Agent

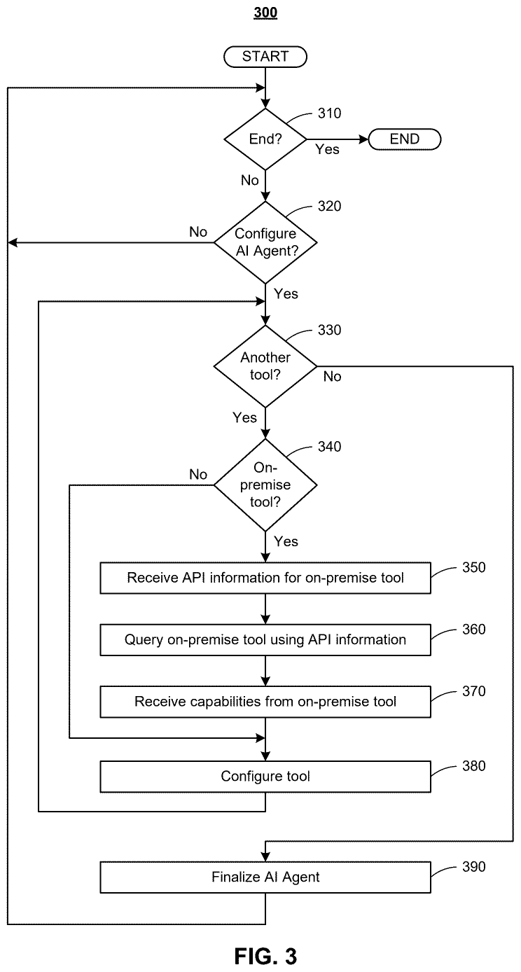

FIG. 3 illustrates a process 300 for configuring an artificial intelligence (AI) agent 150 that may utilize on-premise tools 160A, according to an embodiment. Process 300 may be implemented by AI agent 150 or a supporting system. While process 300 is illustrated with a certain arrangement and ordering of subprocesses, process 300 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 310 may determine whether or not to end process 300. Process 300 may be performed indefinitely, for example, for as long as AI agent 150 is operational, and end when the operation of AI agent 150 is terminated. For as long as process 300 has not been ended (i.e., “No” in subprocess 310), process 300 may proceed to subprocess 320. Otherwise, when process 300 is ended (i.e., “Yes” in subprocess 310), process 300 may end.

Subprocess 320 may determine whether or not to configure an AI agent 150 within cloud-computing environment 110. This configuration may be performed in response to receiving a request to configure AI agent 150. In a contemplated embodiment, the request to configure AI agent 150 is received during installation of AI agent 150. For example, the request to configure AI agent 150 may be received at a time of, or during, execution of AI agent 150 (e.g., at the start of execution, before or at the time that a tool 160 must be utilized, at any arbitrary time in response to one or more user operations, etc.). In an alternative embodiment, a user may perform one or more user operations to deploy a new instance of an AI agent 150, from a registry of AI agents 150 on platform 110, to cloud-computing environment 110, at which time AI agent 150 may be configured. In response to the request to configure AI agent 150, process 300 may initiate a process, comprising subprocesses 330-390, to generate or update a specification of AI agent 150. When determining that an AI agent 150 is to be configured (i.e., “Yes” in subprocess 320), process 300 may proceed to subprocess 330. Otherwise, when not determining that an AI agent 150 is to be configured (i.e., “No” in subprocess 320), process 300 may return to subprocess 310, for example, to await a new configuration request.

Subprocess 330 may determine whether or not AI agent 150 utilizes a tool 160 that remains to be configured. As discussed elsewhere herein, an AI agent 150 may utilize one or more tools 160. Each tool 160 may be either an on-premise tool 160A or cloud-based tool 160B. An on-premise tool 160A may be hosted on an on-premise system 140, whereas a cloud-based tool 160B may be hosted in cloud-computing environment 110. Of particular relevance to disclosed embodiments, AI agent 150 may utilize at least one on-premise tool 160A to perform a task. When determining that a tool 160 remains to be configured (i.e., “Yes” in subprocess 330), process 300 may select the next tool 160 and proceed to subprocess 340. In this manner, an iteration of subprocesses 340-380 may be performed for each tool 160 that is utilized by AI agent 150. Otherwise, when determining that no tools 160 remain to be configured (i.e., “No” in subprocess 330), process 300 may proceed to subprocess 390.

Subprocess 340 may determine whether or not the selected tool 160 is an on-premise tool 160A or cloud-based tool 160B. This determination may be made based on a user selection, a network address of the selected tool, and/or the like. When determining that the selected tool 160 is an on-premise tool 160A (i.e., “Yes” in subprocess 340), process 300 may proceed to subprocess 350. Otherwise, when determining that the selected tool 160 is not an on-premise tool 160A (e.g., but rather, a cloud-based tool 160B), process 300 may proceed to subprocess 380.

Subprocess 350 may receive API information for the selected tool 160, which was determined to be an on-premise tool 160A in subprocess 340. The API information may be retrieved from memory and/or received via a user operation in which a user inputs the API information (e.g., via the graphical user interface of user interface 155). This API information may comprise, without limitation, endpoint information about the application programming interface 165A (e.g., base Uniform Resource Locator (URL), paths for functionalities, HTTP methods, port number, etc.), authentication information (e.g., authentication type, API keys, authorization tokens, etc.), request parameters (e.g., path parameters, query parameters, headers, body parameters, mandatory fields, optional fields, expected structure, etc.), response details (e.g., response format, status codes, error codes, etc.), rate limits (e.g., maximum requests allowed per time period, backoff or retry information when limits are exceeded, etc.), data schema for inputs and/or outputs, security requirements (e.g., HTTPS), and/or the like.

Subprocess 360 may query on-premise tool 160A, for the capabilities of on-premise tool 160A, based on the API information received in subprocess 350. For example, subprocess 360 may generate a query comprising a request for all operations available from on-premise tool 160. Subprocess 360 may then send the generated query to an appropriate endpoint specified in the API information.

Application programming interface 165A of each on-premise tool 160A may implement a common predefined discovery operation (e.g., a GET operation) that enables the discovery of the tool's capabilities. Thus, subprocess 360 may query the predefined discovery operation, within application programming interface 165A of on-premise tool 160A, based on the API information. The discovery operation may be have a common interface (e.g., function name, input(s), output(s), etc.) across all application programming interfaces 165A of all on-premise tools 160A, and potentially all tools 160 (i.e., including cloud-based tools 160B), such that the discovery operation can be called in the exact same manner for every on-premise tool 160A, and potentially for every tool 160.

Each discovery operation may retrieve a list of operations available through application programming interface 165A of on-premise tool 160A, including the input field(s) and/or output field(s) of each listed operation and/or a data schema of the listed operation, as well as an indication of whether each field is mandatory or optional. The discovery operation may retrieve the list of operations from a knowledgebase of on-premise system 140 and/or on-premise tool 160A. The operations in the list may be represented in a standard format, across all discovery operations, for example, as a set of verbs and nouns (e.g., “ORDER” a “LAPTOP”). This list of operations may be returned by the discovery operation, as the queried capabilities, in any well-known format, such as eXtensible Markup Language (XML), JavaScript Object Notation (JSON), or the like.

Subprocess 370 may receive the capabilities of the on-premise tool 160A, which was queried in subprocess 360, from the predefined discovery operation of application programming interface 165A of that on-premise tool 160A. As discussed above, the returned capabilities may comprise or consist of a list of operations (e.g., as verbs or nouns, or in another format), including mandatory and/or optional input and/or output fields for each operation in the list. The use of the common predefined discovery operation within every application programming interface 165A of every on-premise tool 160A enables process 300 to seamlessly obtain the capabilities of every on-premise tool 160A in an automated (e.g., not requiring human intervention), scalable (e.g., not hindered by the number of on-premise tools 160A that need to be integrated), and dynamic (e.g., able to adapt as on-premise tools 160A are modified or otherwise evolve) manner.

Subprocess 380 may configure the tool 160 that was selected in subprocess 330, which may or may not be an on-premise tool 160A processed through subprocesses 350-370. Configuring tool 160 may comprise incorporating the API information for the tool into the specification of AI agent 150, incorporating at least a subset of operations, including any field(s) to be utilized, from the capabilities of the tool 160 into the specification of AI agent 150, and/or the like. With respect to the operations, at least a subset of the operations may be registered as available to AI agent 150 during subsequent execution of AI agent 150. For example, the user may select all or a subset of operations to be registered as available to AI agent 150 via user interface 155. In this case, the graphical user interface of user interface 155 may provide a visual representation of every operation, returned by the discovery operation for a given on-premise tool 160A, along with an input for selecting each operation, and the user may select those operation(s) that the user wishes to make available to AI agent 150. It should be understood that AI agent 150 will only be able to utilize those operations, for a given on-premise tool 160A, that have been selected. Any unselected operations will not be available to (i.e., not registered) AI agent 150 for the given on-premise tool 160A. In other words, the user may be prompted to select one or more operations, a selection of at least one operation may be received from the user, and the selected operation(s) may be registered as available to AI agent 150 during execution of AI agent 150, without registering any unselected operations. In an alternative or additional embodiment, all operations of an on-premise tool 160A may be registered as available to AI agent 150, or the subset of operations may be selected in a different manner, such as, automatically, based on one or more criteria. Cloud-based tools 160B may be configured in a similar, identical, or different manner, as on-premise tools 160A. However, generally, the capabilities of a cloud-based tool 160B, within cloud-computing environment 110, will already be known. In any case, after the selected tool 160 has been configured, process 300 may return to subprocess 330 to determine whether or not another tool 160 remains to be configured.

Subprocess 390 may finalize AI agent 150. For example, subprocess 390 may finalize the specification of AI agent 150. The specification of AI agent 150 may define all of the attributes of AI agent 150, which dictate how AI agent 150 will operate within cloud-computing environment 110. These attributes include the configuration of each tool 160, including any on-premise tools 160A. In addition, these attributes may define operating parameters of each AI model (e.g., generative language model) that AI agent 150 may utilize, as discussed elsewhere herein. One or more of these attributes may be automatically defined and/or one or more of these attributes may be manually defined (e.g., by a user via the graphical user interface). Once finalized, AI agent 150 may be deployed to cloud-computing environment 110. Alternatively, in an embodiment in which AI agent 150 is configured dynamically during execution, the operation of AI agent 150 may be updated within cloud-computing environment 110, based on the newly configured tools 160. In this case, new tools 160 and/or operations may be registered to (i.e., made available to) AI agent 150 and/or existing tools 160 and/or operations may be deregistered from (i.e., no longer available to) AI agent 150.

### 4. Example Execution of AI Agent

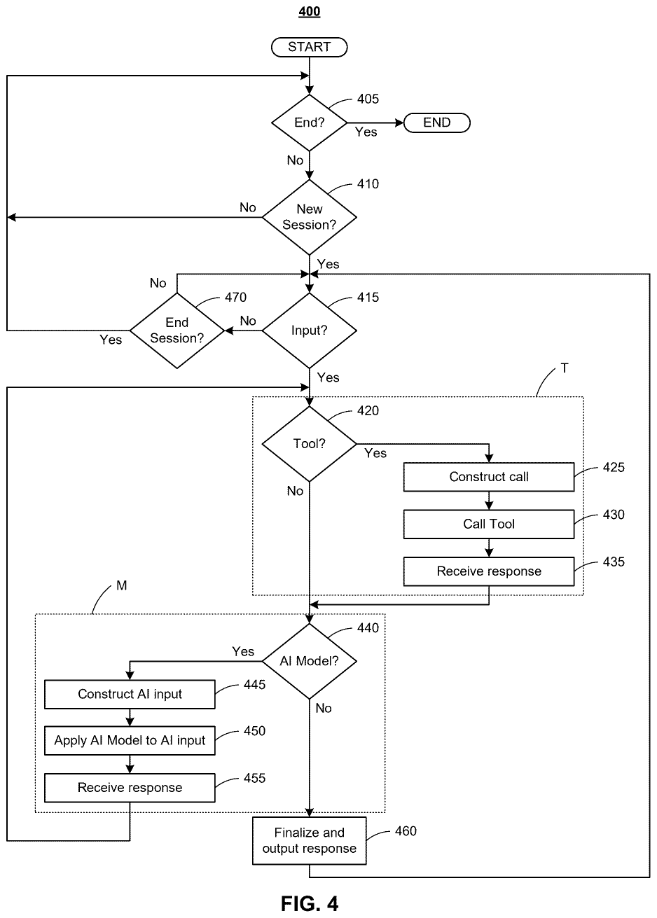

FIG. 4 illustrates a process 400 for executing an artificial intelligence (AI) agent 150 that may utilize on-premise tools 160A, according to an embodiment. Process 400 may be implemented by each AI agent 150, once that AI agent 150 has been deployed (e.g., within cloud-computing environment 110), and during execution of that AI agent 150, and may be triggered by a user operation (e.g., via user interface 155). For the sake of explication, it is assumed, for the purposes of describing process 400, that AI agent 150 is a chat agent that implements real-time chat sessions with users. However, it should be understood that process 400 may be modified to suit other types of AI agents 150. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 405 may determine whether or not to end process 400. Process 400 may be performed for as long as the implementing AI agent 150 is operational. Once AI agent 150 has been deployed, process 400 may be performed until AI agent 150 is undeployed or otherwise terminated. For as long as the operation of AI agent 150 continues (i.e., “No” in subprocess 405), process 400 may proceed to subprocess 410. Otherwise, when the operation of AI agent 150 ends (i.e., “Yes” in subprocess 405), process 400 may end.

Subprocess 410 may determine whether or not to initiate a new session between a user and AI agent 150. The initiation of a new session may be triggered by a user operation, such as the selection of an input by the user within the graphical user interface of user interface 155, the navigation of the user to a particular screen of the graphical user interface, and/or the like. When determining to initiate a new session (i.e., “Yes” in subprocess 410), process 400 may proceed to subprocess 415 to begin the new session. Otherwise, while not determining to initiate a new session (i.e., “No” in subprocess 410), process 400 may return to subprocess 405, for example, to await the initiation of a new session or the end of process 400.

In a contemplated embodiment, each session is a real-time chat session, in which the user interacts with AI agent 150 using natural-language inputs, and AI agent 150 interacts with the user using natural-language responses. The natural-language inputs and/or responses may be provided in a textual format or an audio format (e.g., using a text-to-speech engine to convert the user's speech to text to be processed by AI agent 150, and/or a speech-to-text engine to convert the textual response of AI agent 150 into speech to be output to the user). As used herein, the term “natural language” or “natural-language” refers to language, including grammar, that would be expected in a normal conversation between two humans.

Subprocess 415 may determine whether or not a new input has been received within the session. For example, the user may type a textual input into a textbox within the graphical user interface of user interface 155 and then select an input to submit the textual input, speak an audio input into an audio interface of user interface 155 (e.g., which may then be converted to text via a speech-to-text engine), or the like. More generally, the input may be received from a user (e.g., in the context of a real-time chat session), and may comprise or consist of a natural-language expression. Alternatively, the input may be received from another AI agent 150, an integration process, a third-party application, or the like. When determining that a new input has been received (i.e., “Yes” in subprocess 415), process 400 may proceed to subprocess 420. Otherwise, while not determining that a new input has been received (i.e., “No” in subprocess 415), process 400 may proceed to subprocess 470.

Subprocess 420 may determine whether or not a tool 160 is to be utilized, at the current time, to respond to the input that was received in subprocess 415, based on the current context of the session. For example, a tool 160 may be utilized when AI agent 150 needs to retrieve or send information relevant to the input, perform an action requested by or otherwise in response to the input, and/or perform any other operation using an external system. As discussed elsewhere herein, a tool 160 may be an on-premise tool 160A or a cloud-based tool 160B. In either case, the tool 160 may provide an application programming interface 165 that provides access to one or more operations available to AI agent 150. When determining that a tool 160 is to be utilized, at the current time, to respond to the input (i.e., “Yes” in subprocess 420), process 400 may select the tool 160 and proceed to subprocess 425. Otherwise, when determining that a tool 160 is not to be utilized, at the current time, to respond to the input (i.e., “No” in subprocess 420), process 400 may proceed to subprocess 440.

Subprocess 425 may construct a call to the selected tool 160 based on the input received in subprocess 415. For example, subprocess 425 may select an operation, from available operations of the tool 160, to be performed by the tool 160, determine the value of one or more input fields to the operation, and/or the like. It should be understood that, in the case of an on-premise tool 160A, the available operations, which may be a subset of all operations provided by on-premise tool 160A, may have been previously determined from the capabilities, returned by the discovery operation of application programming interface 165A of the on-premise tool 160A, in process 300. Thus, subprocess 425 may determine at least one of the operations, available within application programming interface 165A of the on-premise tool 160A and available to AI agent 150, to be used in response to the input received in subprocess 415. Subprocess 425 may apply one or more natural-language processing (NLP) techniques to the input to determine which operation to select and the value(s) of any mandatory and/or optional input field(s).

Subprocess 430 may submit the call, constructed in subprocess 425, to the selected tool 160. In particular, subprocess 430 may call the selected operation(s) of the selected tool 160, via the application programming interface 165 of the selected tool 160, using the determined value(s) of any input field(s). It should be understood that each call to a selected operation may be a remote procedure call to a function within the application programming interface 165 of the tool 160. In the case of an on-premise tool 160A, this call will be performed across network(s) 120. As examples, the called operation may retrieve and return, as a result, data from the on-premise system 140 on which on-premise tool 160A is hosted, perform an action through the on-premise system 140 on which on-premise tool 160A is hosted, such as completing a transaction between the on-premise system 140, on which on-premise tool 160A is hosted, and a third-party system, and/or the like.

Subprocess 435 may receive the response to the call that was submitted in subprocess 430. This response may comprise data (e.g., structured data) in the output schema of the selected tool 160, an acknowledgement (e.g., that the call was received, an action was completed, etc.), and/or the like. In general, the response will not be or comprise a natural-language response, unless the tool 160 provides natural-language responses. After receiving the response in subprocess 435, process 400 may proceed to subprocess 440.

Subprocess 440 may determine whether or not an AI model is to be utilized, at the current time, to respond to the input that was received in subprocess 415. For example, a generative AI model may be utilized to generate a natural-language response to the input. AI agent 150 may comprise or have access to a single AI model or a plurality of AI models. When determining that an AI model is to be utilized, at the current time, to respond to the input (i.e., “Yes” in subprocess 440), process 400 may select the AI model and proceed to subprocess 445. Otherwise, when determining that an AI model is not to be utilized, at the current time, to respond to the input (i.e., “No” in subprocess 440), process 400 may proceed to subprocess 460.

Subprocess 445 may construct an AI input to the selected AI model based on the received user input, and/or the response from each tool in the event that any tools 160 were previously utilized. For example, in an embodiment in which the AI model is a generative AI model, such as a generative language model, subprocess 445 may generate a prompt by inserting relevant data, including at least a portion of the user input and/or data from the response of one or more tools 160, into a predefined template. The predefined template may comprise a pre-conversation and/or post-conversation, which provide context and/or instructions for the generative AI model, and one or more placeholders into which the relevant data are inserted. The pre-conversation and/or post-conversation may define the role of the generative AI model (e.g., to summarize the relevant data), define an output format for the generative language model (e.g., a list structure, a hierarchical structure, a markup-language structure, etc.), and/or the like. The prompt may comprise or consist of a natural-language expression.

Subprocess 450 may apply the AI model to the AI input that was constructed in subprocess 445. For example, in an embodiment in which the AI model is a generative AI model, the AI input may comprise a prompt (e.g., comprising or consisting of a natural-language expression) that is submitted to the generative AI model. The AI model will process the AI input to produce a response. While it is generally contemplated that the AI model comprises a generative AI model—and particularly, a generative language model—it should be understood that the AI model could be any type of AI model with any suitable architecture, including without limitation, a generative image model, other types of artificial neural networks, a random forest algorithm, a linear regression algorithm, a logistic regression algorithm, a decision tree, a support vector machine (SVM), a naïve Bayes algorithm, a k-Nearest Neighbors (kNN) algorithm, a K-means algorithm, a dimensionality reduction algorithm, a gradient-boosting algorithm, a Markov chain, a compact prediction tree (CPT), ensemble models, and/or the like.

In an embodiment, one or more AI models may be separate and independent from the AI agents 150 that utilize them. In this case, each AI model may provide an application programming interface that defines how AI agents 150 may interact with the AI model. For example, the AI model may be provided as a microservice (e.g., within cloud-computing environment 110). An AI agent 150 may query the AI model, using the AI input, via the application programming interface of the AI model. It should be understood that a plurality of AI agents 150 may utilize the same AI model in this manner.

Subprocess 455 may receive the response to the AI input (i.e., AI output) from the AI model. In an embodiment in which the AI model is a generative language model, this AI output may comprise or consist of a natural-language expression. After receiving the AI output in subprocess 455, process 400 may return to subprocess 420.

Notably, subprocesses 420-435 form a tool subprocess T that acquires a response from a tool 160, and subprocesses 440-455 form a model subprocess M that acquires a response from an AI model. It should be understood that these tool and model subprocesses may be performed in any order, depending on the task of AI agent 150 and/or the input received in subprocess 415. For example, if the AI model requires particular data to generate a response, the tool subprocess T may be performed first to retrieve the particular data using a tool 160, and then the model subprocess M may be performed second to process (e.g., summarize, format, etc.) the retrieved data using the AI model. In an embodiment in which the AI model is a generative language model, this may comprise generating a prompt based on the result of a call to at least one operation of at least one tool 160, and inputting the prompt to the generative language model to produce a response to the input received in subprocess 415. As another example, if a tool 160 requires the output of the AI model, the model subprocess M may be performed first to obtain the AI output, and then the tool subprocess T may be performed to submit the AI output to the tool 160 and receive a response from the tool 160. In other words, a response to the input, received in subprocess 415, may be generated using an AI model and a result of a call to at least one operation of a tool 160.

In addition, these tool and model subprocesses may be combined into a larger sequence in which the same tool 160 is used at a plurality of different times (e.g., in which case, the tool subprocess T may be performed at each time, potentially with one or more intervening tool or model subprocesses), a plurality of different tools 160 are used (e.g., in which case, the tool subprocess T may be performed for each tool 160, serially or in parallel), the same AI model is used at a plurality of different times (e.g., in which case, the model subprocess M may be performed at each time, potentially with one or more intervening tool or model subprocesses), a plurality of different AI models are used (e.g., in which case, the model subprocess M may be performed for each model), and/or the like, to generate the response to a single user input. For example, data may be retrieved from a plurality of different tools 160 using parallel tool subprocesses T, and then summarized into a natural-language response using a model subprocess M. As another example, data may be retrieved from one or more tools 160 using tool subprocess(es) T, an action may be determined using a model subprocess M, and the action may be executed by a tool 160 using a tool subprocess T. It should be understood that these are simply a couple examples, and that the tool(s) 160 and AI model(s) may be used in any sequences and combinations that are suitable for the task of AI agent 150.

It should be understood that, in some cases, AI agent 150 may need to collect information from a user before AI agent 150 can utilize a tool 160. For example, tool 160 may require a plurality of input fields. In this case, AI agent 150 may execute a series of model subprocesses M to collect the information (e.g., piece by piece), as would be expected in a natural customer-service interaction, until all of the information, required to determine the values of the input fields, has been obtained from the user. At this point, AI agent 150 could execute a tool subprocess T to call tool 160 using the determined values of the input fields.

Subprocess 460 may finalize and output a response to the input that was received in subprocess 415. Assuming that the input was received from a user, the response may be output to the user, for example, within a chat frame, representing a real-time chat session, in a graphical user interface of user interface 155. Finalization of the response may comprise formatting the response into a visual representation that can be displayed within the graphical user interface of user interface 155, converting the response from text to speech using a text-to-speech engine for playback at a user system 130, and/or the like. The response may comprise or otherwise be based on one or more responses that were received from an AI model in an iteration of subprocess 455, and/or one or more responses that were received from a tool 160, including potentially an on-premise tool 160A, in an iteration of subprocess 435.

In an embodiment in which AI agent 150 implements a real-time chat session, the final output response may comprise or consist of a natural-language expression. For example, if the user input is a question, the response, returned by AI agent 150, may be an answer to the question. As another example, if the user input is a request to perform an action, the response, returned by AI agent 150, may be a result of the request, such as details of the completed action if AI agent 150 was able to complete the action, or a reason why the action could not be completed if AI agent 150 was unable to complete the action. For instance, if AI agent 150 is a procurement agent, the action may be a transaction (e.g., to purchase a computer), and the response may comprise transaction details (e.g., order confirmation number, line-item costs of the purchase, shipping information, specification of the computer, etc.).

Subprocess 470 may determine whether or not to end the current session. AI agent 150 may continue to respond to inputs (e.g., from a user), for as long as the session remains active. The end of a session may be triggered by a user operation, such as the selection of an input, by the user, within the graphical user interface of user interface 155, the navigation of the user away from the screen (e.g., chat frame) in which the interaction with AI agent 150 takes place, the expiration of a timeout period after the most recent user input, and/or the like. When determining to end the session (i.e., “Yes” in subprocess 470), process 400 may return to subprocess 405 and await the end of process 400 or the initiation of a new session (e.g., by the same user or a different user). Otherwise, while not determining to end the session (i.e., “No” in subprocess 470), process 400 may return to subprocess 415 to await a new input.

It should be understood that a single AI agent 150 may service a plurality of users. Thus, iterations of subprocesses 410-470 may be performed in parallel and/or in series for a plurality of different users, with each user interacting with the same AI agent 150 within a different, independent session. In an embodiment, the same AI agent 150 may utilize different tools for different users. For example, two different users may have different on-premise systems 140, hosting their own respective organization-specific copy of the same on-premise tool 160A. In this case, AI agent 150 may operate in an identical manner for each of the two users, but when needing to access the tool 160 during one of the user's session, will access the respective organization-specific copy of the on-premise tool 160A hosted on that user's respective on-premise system 140. Consequently, the operations of AI agent 150 may be identical for all users of all organizations, but still capable of providing organization-specific responses, due to the organization-specific data being provided by each organization's specific copy of on-premise tool(s) 160.

### 5. Example Execution of AI Agent

As mentioned throughout this disclosure, a contemplated embodiment is that an AI agent 150, hosted in cloud-computing environment 110, implements a real-time natural-language chat session with a user, using one or more on-premise tools 160 that are hosted on an on-premise system 140 (e.g., operated by the user's organization) for enhanced chat operations. Cloud-computing environment 110 may be hosted on a platform, which may be, but is not required to be, an iPaaS platform.

The capabilities, including operations, of each on-premise tool 160 may be automatically learned, during installation of the AI agent 150, by querying a discovery operation provided by the application programming interface 165A of the on-premise tool 160A. Alternatively, AI agent 150 may query the discovery operation, on demand, whenever on-premise tool 160A needs to be called. In particular, when determining that an on-premise tool 160A is required, AI agent 150 may first query the discovery operation provided by application programming interface 165A of on-premise tool 160A to obtain the capabilities of on-premise tool 160A.

During execution, each AI agent 150 may call the learned operations of the on-premise tool 160A to complete the agent's task, which may comprise responding to user inputs within the chat session. In particular, during the chat session, AI agent 150 may utilize its training to understand user inputs and decide when an API call to an operation of an on-premise tool 160A is needed. When such an API call is needed, AI agent 150 may gather the necessary information from the user, based on the input fields specified for the respective operation within the learned capabilities of on-premise tool 160A, and then execute the API call using the gathered information. On-premise tool 160A may validate the API call, translate it into an appropriate operation, and execute the operation, and then respond to the API call, with the result of the executed operation, in the format specified in the learned capabilities. The ability of AI agent 150 to handle structured inputs and outputs enables AI agent 150 to appropriately adapt its response to the user's input.

As a concrete example for the purposes of illustration, a user may interact with a cloud-based AI agent 150 to order a laptop for the user's organization. During the chat session, AI agent 150 may determine that this action needs to be performed through the organization's on-premise tool 160A. Thus, AI agent 150 may gather the necessary information from the user, as determined from the fields specified in the capabilities returned by the discovery operation of on-premise tool 160A, such as laptop model, shopping address, and/or the like, and then make the API call to on-premise tool 160A. On-premise tool 160A may complete the purchase of the laptop, according to the fields provided in the API call, and respond with confirmation details regarding the purchase, which AI agent 150 may then translate into a natural-language response using a generative AI model.

It should be understood that copies of the same on-premise tool 160A for different organizations may require different information (e.g., different fields). For example, a first organization may require the desired color of the laptop, in order to make a purchase, whereas a second organization may not. Advantageously, these requirements are learned using the discovery operation of application programming interface 165A of each on-premise tool 160A, either during installation of AI agent 150, or on the fly before executing an API call to an operation of on-premise tool 160A.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, for each of one or more artificial-intelligence (AI) agents:
receive a request to configure the AI agent within a cloud-computing environment, wherein the AI agent utilizes at least one on-premise tool to perform a task, and wherein the at least one on-premise tool is hosted on an on-premise system that is remote from the cloud-computing environment;
receive application programming interface (API) information for the at least one on-premise tool;
query a predefined discovery operation, within an application programming interface of the at least one on-premise tool, based on the API information;
receive capabilities of the at least one on-premise tool from the predefined discovery operation, wherein the capabilities comprise one or more operations available within the application programming interface of the at least one on-premise tool; and
register at least a subset of the one or more operations, as available to the AI agent during subsequent execution of the AI agent.

2. The method of claim 1, wherein the one or more AI agents are a plurality of AI agents, and wherein all of the application programming interfaces of all of the on-premise tools include the predefined discovery operation.

3. The method of claim 1, wherein the capabilities further comprise a list of fields for each of the one or more operations.

4. The method of claim 3, wherein the list of fields comprises one or both of one or more input fields or one or more output fields.

5. The method of claim 1, wherein the capabilities further comprise a data schema of each of the one or more operations.

6. The method of claim 1, wherein the request to configure the AI agent is received during installation of the AI agent.

7. The method of claim 1, wherein the request to configure the AI agent is received at a time of or during execution of the AI agent.

8. The method of claim 1, wherein the one or more operations are a plurality of operations, and wherein registering at least a subset of the one or more operations as available to the AI agent during execution of the AI agent comprises:
prompting a user to select one or more of the plurality of operations;
receiving a selection of at least one of the plurality of operations from the user; and
registering the selected at least one operation, without registering any unselected ones of the plurality of operations, as the at least a subset of the one or more operations that are available to the AI agent during execution of the AI agent.

9. The method of claim 1, further comprising, for each of the one or more AI agents, during execution of the AI agent:
receive an input from a user;
determine at least one of the at least a subset of the one or more operations, available within the application programming interface of the at least one on-premise tool and available to the AI agent, to be used in response to the input; and
call the at least one operation.

10. The method of claim 9, further comprising, for each of the one or more AI agents, during execution of the AI agent:
generate a response to the input using an AI model and a result of the call to the at least one operation; and
output the response to the user.

11. The method of claim 10, wherein the AI model is a generative language model, and wherein the response comprises a natural-language expression.

12. The method of claim 11, wherein generating the response to the input comprises:
generating a prompt based on the result of the call to the at least one operation; and
inputting the prompt to the generative language model to produce the response.

13. The method of claim 11, wherein the AI agent implements a real-time chat session with the user, and wherein the input comprises a natural-language expression.

14. The method of claim 9, wherein the at least one operation retrieves and returns, as a result, data from the on-premise system on which the at least one on-premise tool is hosted.

15. The method of claim 9, wherein the at least one operation performs an action through the on-premise system on which the at least one on-premise tool is hosted.

16. The method of claim 15, wherein the action comprises completing a transaction between the on-premise system, on which the at least one on-premise tool is hosted, and a third-party system.

17. The method of claim 1, wherein the cloud-computing environment is hosted on an integration platform as a service (iPaaS) platform.

18. A system comprising:
at least one hardware processor; and
software that is configured to, when executed by the at least one hardware processor, for each of one or more artificial-intelligence (AI) agents,
receive a request to configure the AI agent within a cloud-computing environment, wherein the AI agent utilizes at least one on-premise tool to perform a task, and wherein the at least one on-premise tool is hosted on an on-premise system that is remote from the cloud-computing environment,
receive application programming interface (API) information for the at least one on-premise tool,
query a predefined discovery operation, within an application programming interface of the at least one on-premise tool, based on the API information,
receive capabilities of the at least one on-premise tool from the predefined discovery operation, wherein the capabilities comprise one or more operations available within the application programming interface of the at least one on-premise tool, and
register at least a subset of the one or more operations, as available to the AI agent during subsequent execution of the AI agent.

19. A non-transitory computer-readable medium having instructions stored therein, wherein the instructions, when executed by a processor, cause the processor to, for each of one or more artificial-intelligence (AI) agents:
receive a request to configure the AI agent within a cloud-computing environment, wherein the AI agent utilizes at least one on-premise tool to perform a task, and wherein the at least one on-premise tool is hosted on an on-premise system that is remote from the cloud-computing environment;
receive application programming interface (API) information for the at least one on-premise tool;
query a predefined discovery operation, within an application programming interface of the at least one on-premise tool, based on the API information;
receive capabilities of the at least one on-premise tool from the predefined discovery operation, wherein the capabilities comprise one or more operations available within the application programming interface of the at least one on-premise tool; and
register at least a subset of the one or more operations, as available to the AI agent during subsequent execution of the AI agent.
